(19) United States
(12) Patent Application Publication
(10) Pub. No.: US 2007/0270154 A1
(43) Pub. Date: Nov. 22, 2007

(54) Apparatus and method for scheduling using channel varation in a broadband wireless communication system

(75) Inventors: Nam-Gi Kim, Suwon-si (KR); Chung-Ryul Chang, Yongin-si (KR); Eun-Chul Yoon, Yongin-si (KR)

Correspondence Address: THE FARRELL LAW FIRM, P.C., 333 EARLE OVINGTON BOULEVARD, SUITE 701, UNIONDALE, NY, 11553, US

(73) Assignee: SAMSUNG ELECTRONICS CO., LTD., Suwon-si (KR)

(21) Appl. No.: 11/804,101

(22) Filed: May 17, 2007

(30) Foreign Application Priority Data
May 18, 2006 (KR) 2006-0044483

(51) Int. Cl. H04Q 7/20

(52) U.S. Cl. 455/450

(57) ABSTRACT

An apparatus and method for allocating radio resources in a wireless communication system are provided, in which a channel variation detector detects channel variations of mobile stations (MSs) using channel information estimated from a sounding channel included in a received signal and a scheduler determines sounding channel allocation periods for the MSs and selects MSs to which the radio resources will be allocated according to the channel variations of the MSs.

### PRIORITY

This application claims priority under 35 U.S.C. §119 to an application entitled “Apparatus and Method for Scheduling Using Channel Variation in a Broadband Wireless Communication System” filed in the Korean Intellectual Property Office on May 18, 2006 and assigned Serial No. 2006-44483, the contents of which are incorporated herein by reference.

### BACKGROUND OF THE INVENTION

1. Field of the Invention

The present invention relates generally to a scheduling apparatus and method in a broadband wireless communication system, and in particular, to an apparatus and method for scheduling spatial resources in a Time Division Duplex-Spatial Division Multiple Access (TDD-SDMA) system.

2. Description of the Related Art

The Institute of Electrical and Electronics Engineers (IEEE) 802.16 Wireless Metropolitan Area Network (WMAN) standard provides a standardized SDMA scheme through the use of adaptive antennas in a broadband wireless communication system. The adaptive antenna-based SDMA system spatially allocates the same time-frequency resources to a plurality of users at a given time by forming different beams for the users, thereby increasing system capacity.

Because severe spatial interference makes it difficult to separate radio resources spatially in a SDMA system, users with less spatial interference are selected and the radio resources are simultaneously allocated to them.

In a TDD system, a single radio channel is divided in time into a downlink and an uplink. If the bi-directional channels do not change much over time, they are symmetrical.

A TDD-SDMA system estimates the interference of each user using a sounding code signal received on an uplink sounding channel by exploiting channel reciprocity. Specifically, each user transmits a sounding code signal to a Base Station (BS) on the sounding channel and the BS estimates mutual interference between users based on sounding code signals received from them.

FIG. 1 illustrates a frame structure in a conventional TDD broadband wireless communication system.

Referring to FIG. 1, frames 100, 110 and 120 are each divided in time into a downlink subframe and an uplink subframe.

The downlink subframe includes a preamble (PRM), common control information (MAP), and downlink data traffic (DATA) that are time-multiplexed.

The uplink subframe includes control information (CTRL) (which may include a ranging channel, a Channel Quality Indicator (CQI) channel, and an ACKnowledgement (ACK) channel), uplink data traffic (DATA), and a sounding channel (SND), which are time-multiplexed.

Users transmit to a BS sounding code signals on sounding channels allocated in the uplink subframe. The BS measures mutual interference between the users using the sounding code signals and selects users to which the same radio resources will be allocated according to the interference estimates.

A problem with the above conventional method is that there is a discrepancy in time between the interference estimation and the resource allocation based on the interference estimates. The time discrepancy is caused by the characteristics of the system, computational complexity, and the capacity of the sounding channel.

As channels vary for users in the broadband wireless communication system, the time discrepancy between the interference estimation and the spatial resource allocation means that the channels may change during the time period between the two points in time. Consequently, the users to which the radio resources are allocated suffer from decreased reception performance due to channel variation-incurred mutual interference.

Moreover, for a user with a fast changing channel, the channel may change greatly during the time between the interference estimation and the resource allocation.

As a result, the resource-allocated users experience channel variations and interference among them increases above an acceptable level, thus making accurate data recovery impossible in the broadband wireless communication system.

### SUMMARY OF THE INVENTION

An aspect of the present invention is to substantially solve at least the above problems and/or disadvantages and to provide at least the advantages below. Accordingly, an aspect of the present invention is to provide an apparatus and method for measuring the channel variation of each user using a sounding channel in a TDD-SDMA system.

Another aspect of the present invention is to provide an apparatus and method for scheduling radio spatial resources according to channel variations measured from a sounding channel in a TDD-SDMA system.

A further aspect of the present invention is to provide an apparatus and method for determining a sounding channel allocation period according to a channel variation measured from a sounding channel in a TDD-SDMA system.

Still another aspect of the present invention is to provide an apparatus and method for selecting users to which radio resources will be allocated according to their channel variations in a TDD-SDMA system.

According to an aspect of the present invention, there is provided an apparatus for allocating radio resources in a wireless communication system, in which a channel variation detector detects channel variations of mobile stations (MSs) using channel information estimated from a sounding channel included in a received signal and a scheduler determines sounding channel allocation periods for the MSs and selects MSs to which the radio resources will be allocated according to the channel variations of the MSs.

According to another aspect of the present invention, there is provided a method for allocating radio resources in a wireless communication system, in which channel variations of MSs are detected using channel information estimated from a sounding channel included in a received signal, and MSs to which the radio resources will be allocated are selected according to the channel variations of the MSs.

According to a further aspect of the present invention, there is provided a method for allocating a sounding channel in a wireless communication system, in which channel variations of MSs using channel information estimated from the sounding channel included in a received signal are detected and sounding channel allocation periods are determined for the MSs according to the channel variations of the MSs.

### BRIEF DESCRIPTION OF THE DRAWINGS

The above and other objects, features and advantages of the present invention will become more apparent from the following detailed description when taken in conjunction with the accompanying drawings in which:

FIG. 1 illustrates a frame structure in a conventional TDD broadband wireless communication system;

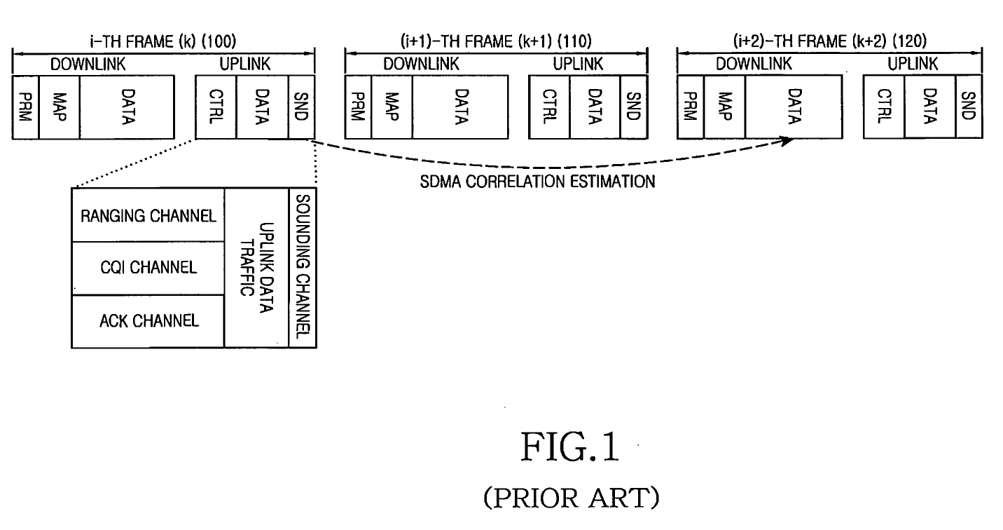

FIG. 2 illustrates sounding channel allocation periods in a TDD broadband wireless communication system according to the present invention;

FIG. 3 is a block diagram of a receiver for receiving a sounding channel in the broadband wireless communication system according to the present invention;

FIG. 4 is a detailed block diagram of a scheduler in the broadband wireless communication system according to the present invention;

FIG. 5 is a flowchart illustrating an operation for setting an SDMA user group of which the users will be spatially multiplexed according to channel variations in the broadband wireless communication system according to an embodiment of the present invention; and

FIG. 6 is a flowchart illustrating an operation for controlling a sounding channel allocation period according to a channel variation in the broadband wireless communication system according to an embodiment of the present invention.

### DETAILED DESCRIPTION OF THE PREFERRED EMBODIMENTS

Preferred embodiments of the present invention Will be described herein below with reference to the accompanying drawings. In the following description, well-known functions or constructions are not described in detail since they would obscure the invention in unnecessary detail.

The present invention discloses a technique for scheduling radio resources using channel information estimated from a sounding channel in a TDD-SDMA system.

While the present invention will be described in the context of an Orthogonal Frequency Division Multiple Access (OFDMA) communication system, it is to be clearly understood that the present invention is also applicable to communication systems using other multiple access schemes.

The sounding channel is an uplink channel that a BS allocates to MSs so that it can estimate the downlink channel statuses of the users using uplink signals received on the sounding channel in the TDD-SDMA system. For instance, the BS allocates the sounding channel to MSs on a bin basis in a symbol according to the IEEE 802.16 standards. The MSs then transmit sounding code signals to the BS in the allocated bins of the sounding channel. A sounding code signal is created using part of a Golay Sequence of a length of 2048.

The BS can allocate one bin of the sounding channel simultaneously to a plurality of MSs based on the nature of cyclic shift indexes. However, since the capacity of the sounding channel in one frame is too small to accommodate MSs that are serviced at one time, the sounding channel is allocated to them at different intervals.

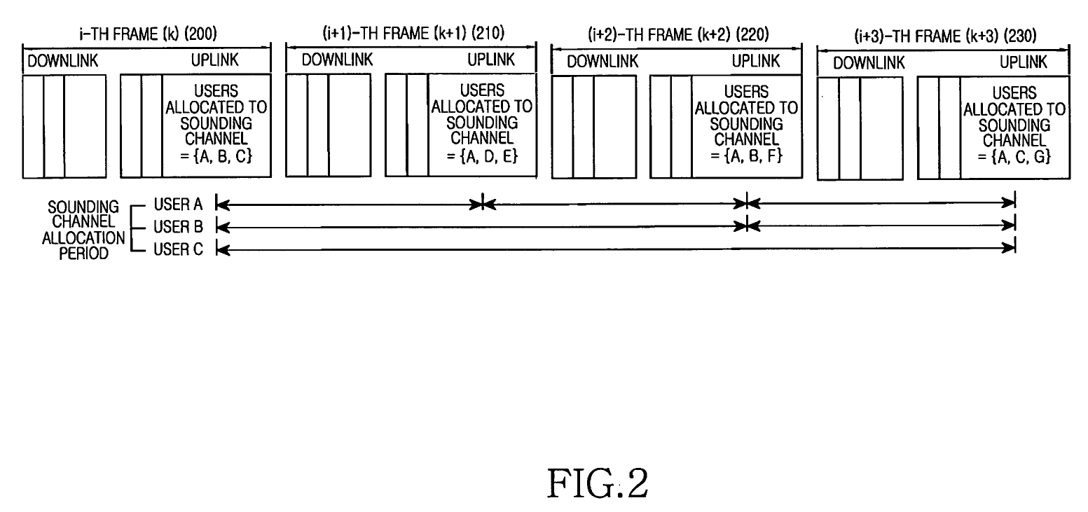

FIG. 2 illustrates sounding channel allocation periods in a TDD broadband wireless communication system according to the present invention.

Referring to FIG. 2, the sounding channel in an uplink subframe cannot be allocated simultaneously to all MSs due to its limited capacity. Therefore, the BS allocates the sounding channel to the MSs in different periods. For example, the BS allocates the sounding channel to a first MS USER A every frame, and to a second MS USER B every other frame.

As described above, the BS allocates the sounding channel to MSs and then estimates the channel statuses of the MSs using sounding code signals received from the MSs on the sounding channel. The BS schedules SDMA resources based on the estimates.

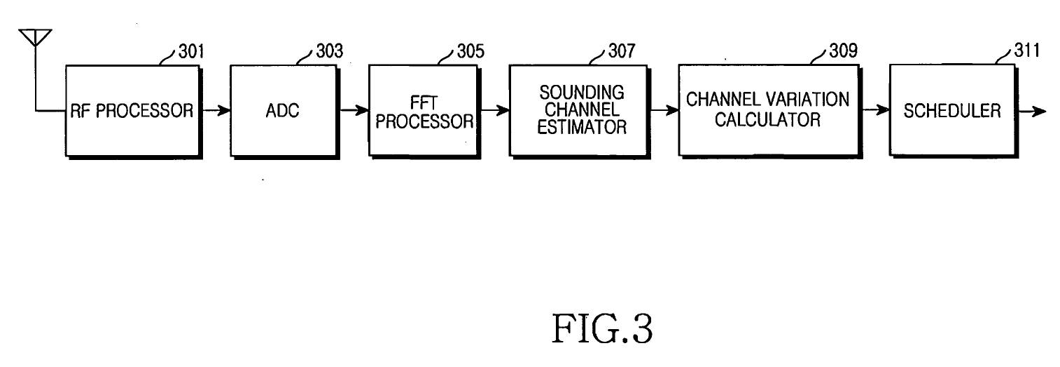

FIG. 3 is a block diagram of a receiver for receiving the sounding channel from MSs in the BS in the broadband wireless communication system according to the present invention.

Referring to FIG. 3, the receiver includes a Radio Frequency (RF) processor 301, an Analog-to-Digital Converter (ADC) 303, a Fast Fourier Transform (FFT) processor 305, a sounding channel estimator 307, a channel variation calculator 309, and a scheduler 311.

The RF processor 301 downconverts an RF signal received through an antenna to a baseband signal. The ADC 303 converts the analog baseband signal received from the RF processor 301 to a digital signal.

The FFT processor 305 converts the time signal received from the ADC 303 to a frequency signal by FFT.

The sounding channel estimator 307 extracts sounding channel signals from the frequency signal and estimates the downlink channel statuses of users using the sounding channel signals. For example, the receiver receives sounding code signals on the sounding channel, expressed as Equation (1)

$$Y = [ \begin{matrix}{H}_{1} \\ {H}_{2} \\ ⋮ \\ {H}_{{M}_{R}}\end{matrix} ] \cdot S + [ \begin{matrix}{N}_{1} \\ {N}_{2} \\ ⋮ \\ {N}_{{M}_{R}}\end{matrix} ] \qquad ( 1 )$$

where Y denotes a sounding code signal received in bins, S denotes a signal transmitted by an MS, Hᵢ denotes a channel for an i^{th} receive antenna, M_{R} denotes the number of receive antennas, and Nᵢ denotes noise at the i^{th} receive antenna.

The sounding channel estimator 307 estimates the sounding channel allocated to each MS on a bin basis by Equation (2)

$${CH}_{est} = [ \begin{matrix}{H}_{1} \\ {H}_{2} \\ ⋮ \\ {H}_{{M}_{R}}\end{matrix} ] = \frac{1}{S} \cdot [ \begin{matrix}{Y}_{1} \\ {Y}_{2} \\ ⋮ \\ {Y}_{{M}_{R}}\end{matrix} ] \qquad ( 2 )$$

where S denotes the signal transmitted by the MS, Hᵢ denotes the channel for the i^{th} receive antenna, Yᵢ denotes a sounding code signal received through the i^{th} receive antenna, M_{R} denotes the number of the receive antennas, and Nᵢ denotes the noise at the i^{th} receive antenna.

The channel variation calculator 309 calculates the channel variation of the MS using the channel estimates of an i^{th} frame (a current frame) and an (i-1)^{th} frame (a previous frame) received from the sounding channel estimator 307. For instance, if N_{B} bins of the sounding channel are allocated to each MS, the channel variation calculator 309 calculates the channel variation of the MS during the time period between the i^{th} frame and the (i-1)^{th} frame using Equation (3)

$${CH}_{cor} = \frac{1}{{N}_{B} \cdot {M}_{R}} \cdot \vert {\sum }_{b = 1}^{{N}_{B}} {\sum }_{r = 1}^{{M}_{R}} \frac{{CH}_{est} [ {f}_{cur} , b , r ] \times {( {CH}_{est} [ {f}_{pre} , b , r ] )}^{*}}{{\vert {CH}_{est} [ {f}_{cur} , b , r ] \times {( {CH}_{est} [ {f}_{pre} , b , r ] )}^{*} \vert}^{2}} \vert \qquad ( 3 )$$

where CH_{cor} denotes the channel variation of the MS, CHₑₛₜ denotes a channel estimate, N_{B} denotes the number of bins of the sounding channel allocated to the MS, M_{R} denotes the number of receive antennas, CHₑₛₜ[f_{cur},b,r] denotes the channel estimate of a b^{th} bin received through an r^{th} antenna in the i^{th} frame, and CHₑₛₜ537 fₚᵣₑ,b,r┘ denotes the channel estimate of the b^{th} bin received through the r^{th} antenna in the (i-1)^{th} frame.

The channel variation calculator 309 normalizes the channel variation according to a time period based on Equation (4)

$${CH}_{nor\_cor} = {CH}_{cor} \cdot \frac{{T}_{min}}{{T}_{actual}} + 1 - \frac{{T}_{min}}{{T}_{actual}} \qquad ( 4 )$$

where CHₙₒᵣ_{_{—}}_{cor} denotes the normalized channel variation, CH_{cor} denotes the channel variation, T_{actual} denotes an actual time difference between the two sounding code signals, and Tₘᵢₙ denotes a minimum system-generated time difference between the two sounding code signals. Calculating the channel variation is equivalent to correlating the i^{th} frame with the (i-1)^{th} frame of the sounding channel. Hence, as the channel variation increases, the less the sounding channel changes.

The scheduler 311 groups MSs to which radio spatial resources will be allocated as an SDMA user group according to the channel variations of MSs received from the channel variation calculator 309 and determines sounding channel allocation periods for the selected MSs according to their channel variations.

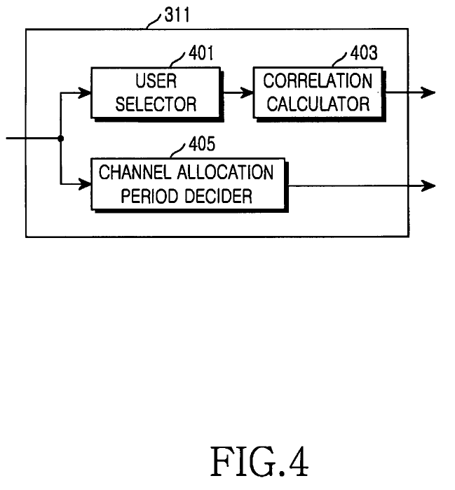

FIG. 4 is a detailed block diagram of the scheduler in the broadband wireless communication system according to the present invention.

Referring to FIG. 4, the scheduler 311 includes a user selector 401, a correlation calculator 403, and a channel allocation period decider 405.

The user selector 401 selects SDMA MSs based on the channel variations of MSs received form the channel variation calculator 309. For example, since interference information calculated using the sounding channel changes fast for a MS with a fast varying channel, allocation of SDMA resources to the MS may degrade the transmission performance of the system. Therefore, the MS selector 401 selects MSs with less changing channels to prevent the degradation of transmission performance.

The correlation calculator 403 calculates spatial interference between the selected MSs and selects MSs to use the same radio spatial resources.

The channel allocation period decider 405 determines sounding channel periods for MSs according to their channel variations received from the channel variation calculator 309. If a MS has a large channel variation, the channel allocation period decider 405 determines a short sounding channel allocation period for the MS in order to check the channel change of the MS frequently, considering the greater the change to the channel of the MS. On the contrary, a MS has a small channel variation, the channel allocation period decider 405 determines a long sounding channel allocation period for the MS, considering the lesser the change to the channel of the MS. If the channel variation is calculated by correlating the i^{th} frame and the (i-1)^{th} frame of the sounding channel, as the channel variation increases, the channel allocation period decider 405 determines the less that the sounding channel changes.

As described above, the BS schedules SDMA resources according to the channel variations of MSs calculated by the channel variation calculator 309. Now a description will be made of an operation for scheduling SDMA resources according to the channel variations of MSs.

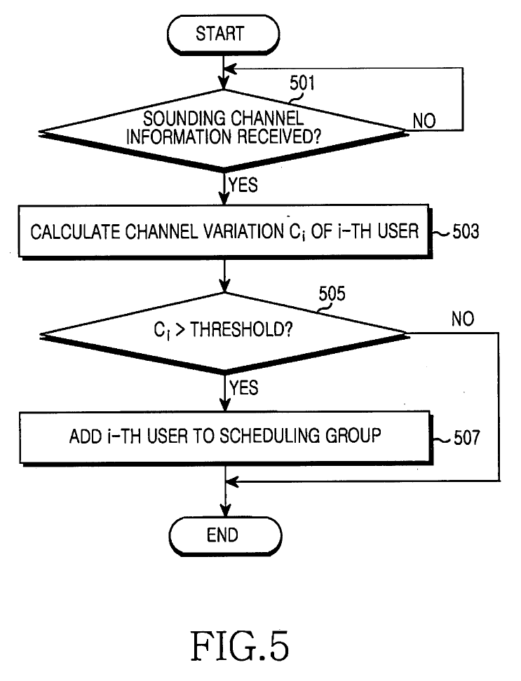

FIG. 5 is a flowchart illustrating an operation for setting an SDMA user group to be spatially multiplexed according to channel variations in the broadband wireless communication system according to an embodiment of the present invention. The following description is made on the assumption that the channel variations are calculated by correlating the i^{th} frame and the (i-1)^{th} frame of the sounding channel, and thus as the channel variations increase, the less the channels change.

Referring to FIG. 5, the receiver monitors reception of a sounding code signal on the sounding channel from an i^{th} user in step 501.

Upon receipt of the sounding code signal, the receiver calculates the channel variation Cᵢ of the i^{th} user by Equation (3) and Equation (4) in step 503.

In step 505, the receiver compares the channel variation Cᵢ with a threshold in order to select MSs whose channels change less.

If Cᵢ is less than or equal to the threshold (Cᵢ≦threshold), the receiver determines that the channel of the i^{th} MS changes greatly because the channel variation is calculated through correlation.

Therefore, the receiver excludes the i^{th} MS from an SDMA user group and ends the algorithm of the present invention.

On the other hand, if Cᵢ is greater than the threshold (Cᵢ>threshold), the receiver includes the i^{th} MS in the SDMA user group, determining that the channel of the i^{th} MS changes less in step 507 and then ends the algorithm of the present invention.

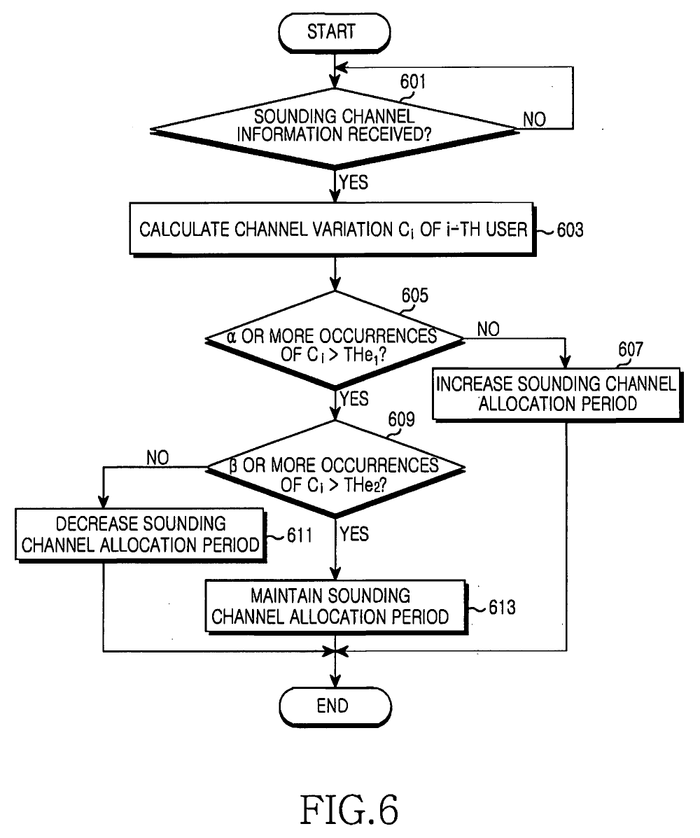

FIG. 6 is a flowchart illustrating an operation for controlling a sounding channel allocation period according to a channel variation in the broadband wireless communication system according to an embodiment of the present invention. The following description is made on the assumption that the channel variation is calculated by correlating the i^{th} frame and the (i-1)^{th} frame of the sounding channel, and thus as the channel variation increases, the less the channel changes.

Referring to FIG. 6, the receiver monitors reception of a sounding code signal on the sounding channel from an i^{th} MS in step 601.

Upon receipt of the sounding code signal, the receiver calculates the channel variation Cᵢ of the i^{th} user by Equation (3) and Equation (4) in step 603.

In step 605, the receiver compares the channel variation Cᵢ with a first threshold THe₁. The receiver compares the number of occurrences Cᵢ being greater than the first threshold (Cᵢ>THe₁) with a in step 605. The first threshold THe₁ is a primary threshold for allocating a current sounding channel period to the i^{th} MS and a is set so as to prevent a rapid change in the sounding channel allocation period according to the channel variation.

If the number of occurrences Cᵢ being greater than the first threshold is greater than or equal to α, the receiver increases the sounding channel allocation period of the i^{th} user in step 607.

If the number of occurrences Cᵢ being greater than the first threshold is less than α, the receiver compares the number of occurrences Cᵢ being less than a second threshold THe₂ (Cᵢ>THe₂) with β in step 609. The second threshold THe₂ is a secondary threshold for allocating the current sounding channel period to the i^{th} MS and β is set in order to prevent a rapid change in the sounding channel allocation period according to the channel variation.

If the number of occurrences Cᵢ being less than the second threshold is greater than or equal to β, the receiver decreases the sounding channel allocation period of the i^{th} user in step 611.

On the other hand, if the number of occurrences Cᵢ being less than the second threshold is less than β, the receiver keeps the current sounding channel allocation period in step 613 and then ends the algorithm of the present invention.

In accordance with the above embodiment of the present invention, the BS sets the primary and secondary allocation period thresholds and compares the channel variation of a MS with them. The BS then determines a sounding channel allocation period for the MS based on the comparison result. The sounding channel allocation period can be changed levelwise according to the primary and secondary allocation period thresholds. Also, the BS can determine the sounding channel allocation period, referring to a look-up table with sounding channel allocation periods mapped to predetermined channel variations.

As is apparent from the above description of the present invention, the channel variations of MSs are estimated using a sounding channel and SDMA users are selected according to the channel variations in the TDD-SDMA system. Therefore, system performance degradation caused by channel estimation errors is minimized and the computation of spatial interference is reduced, thereby reducing system complexity. In addition, as the system allocates a variable sounding channel allocation period to a MS according to the channel variation estimate of the MS, the resulting maximization of the utilization of a small-capacity sounding channel and reduction of sounding information errors increase system performance.

While the invention has been shown and described with reference to certain preferred embodiments thereof, it will be understood by those skilled in the art that various changes in form and details may be made therein without departing from the spirit and scope of the invention as defined by the appended claims.

What is claimed is:

1. An apparatus for allocating radio resources in a wireless communication system, comprising:
a channel variation detector for detecting channel variations of mobile stations (MSs) using channel information estimated from a sounding channel included in a received signal; and
a scheduler for determining sounding channel allocation periods for the MSs and selecting MSs to which the radio resources will be allocated according to the channel variations of the MSs.

2. The apparatus of claim 1, wherein the sounding channel is an uplink channel allocated to the MSs so that downlink channels of the MSs can be estimated using uplink signals received on the uplink channel.

3. The apparatus of claim 1, wherein the channel variation detector comprises:
a sounding channel estimator for estimating the sounding channel using sounding code signals received on the sounding channel and outputting sounding channel estimates; and
a channel variation calculator for calculating the channel variations of the MSs using the sounding channel estimates.

4. The apparatus of claim 1, wherein the scheduler comprises:
a sounding channel period decider for determining the sounding channel allocation periods for the MSs according to the channel variations of the MSs; and
a user selector for selecting the MSs to which the radio resources will be allocated according to the channel variations of the MSs.

5. The apparatus of claim 4, wherein if a MS experiences a channel change greater than a threshold the sounding channel allocation period decider allocates a short sounding channel allocation period for the MS, and if the MS experiences a channel change less than a threshold the sounding channel allocation period decider allocates a long sounding channel allocation period for the MS.

6. The apparatus of claim 4, wherein if a MS experiences a channel change the sounding channel allocation period decider decreases a sounding channel allocation period for the MS, and if the MS experiences a channel change less than a threshold the sounding channel allocation period decider increases the sounding channel allocation period for the MS.

7. The apparatus of claim 4, wherein if the channel variation of a MS is greater than a first threshold more than a predetermined number of times the sounding channel allocation period decider increases a sounding channel allocation period for the MS, and if the channel variation of the MS is less than a second threshold more than a predetermined number of times the sounding channel allocation period decider decreases the sounding channel allocation period for the MS.

8. The apparatus of claim 7, wherein the channel variation, the first threshold, and the second threshold are values calculated by channel correlation.

9. The apparatus of claim 4, wherein the user selector selects MSs with less channel variations, for radio resource allocation.

10. The apparatus of claim 4, wherein the scheduler further comprises a correlation calculator for calculating spatial interference between the selected users, for performing Spatial Division Multiple Access (SDMA).

11. A method for allocating radio resources in a wireless communication system, comprising:
detecting channel variations of mobile stations (MSs) using channel information estimated from a sounding channel included in a received signal; and
selecting MSs to which the radio resources will be allocated according to the channel variations of the MSs.

12. The method of claim 11, wherein the sounding channel is an uplink channel allocated to the MSs so that downlink channels of the MSs can be estimated using uplink signals received on the uplink channel.

13. The method of claim 11, wherein the channel variation detection comprises:
estimating the sounding channel using sounding code signals received on the sounding channel and outputting sounding channel estimates; and
calculating the channel variations of the MSs using the sounding channel estimates.

14. The method of claim 11, wherein the MS selection comprises:
comparing the channel variations of the MSs with a threshold; and
selecting MSs with channel variations less than the threshold.

15. The method of claim 11, further comprising calculating spatial interference between the selected MSs and selecting MSs for which Spatial Division Multiple Access (SDMA) will be performed.

16. A method for allocating a sounding channel in a wireless communication system, comprising:
detecting channel variations of mobile stations (MSs) using channel information estimated from the sounding channel included in a received signal; and
determining sounding channel allocation periods for the MSs according to the channel variations of the MSs.

17. The method of claim 16, wherein the sounding channel is an uplink channel allocated to the MSs so that downlink channels of the MSs can be estimated using uplink signals received on the uplink channel.

18. The method of claim 16, wherein the channel variation detection comprises:
estimating the sounding channel using sounding code signals received on the sounding channel and outputting sounding channel estimates; and
calculating the channel variations of the MSs using the sounding channel estimates.

19. The method of claim 16, wherein the period determination comprises:
allocating a short sounding channel allocation period for a MS if the MS experiences a channel change greater than a threshold; and
allocating a long sounding channel allocation period for the user if the user experiences a channel change less than a threshold.

20. The method of claim 16, wherein the period determination comprises:
decreasing a sounding channel allocation period for a MS if the MS experiences a channel change greater than a threshold; and
increasing the sounding channel allocation period for the MS, if the MS experiences a channel change less than a threshold.

21. The method of claim 16, wherein the period determination comprises:
increasing a sounding channel allocation period for a MS, if the channel variation of the MS is greater than a first threshold more than a predetermined number of times; and
decreasing the sounding channel allocation period for the MS, if the channel variation of the MS is less than a second threshold more than a predetermined number of times.

22. The method of claim 21, wherein the channel variation, the first threshold, and the second threshold are values calculated by channel correlation.

23. An apparatus for allocating a sounding channel in a wireless communication system, comprising:
means for detecting channel variations of mobile stations (MSs) using channel information estimated from the sounding channel included in a received signal; and
means for determining sounding channel allocation periods for the MSs according to the channel variations of the MSs.

24. The apparatus of claim 23, wherein the sounding channel is an uplink channel allocated to the MSs so that downlink channels of the MSs can be estimated using uplink signals received on the uplink channel.

25. The apparatus of claim 23, wherein the means for detecting channel variations comprises:
means for estimating the sounding channel using sounding code signals received on the sounding channel and outputting sounding channel estimates; and
means for calculating the channel variations of the MSs using the sounding channel estimates.
